(19) United States
(12) Patent Application Publication
(10) Pub. No.: US 2024/0249191 A1
(43) Pub. Date: Jul. 25, 2024

(54) SYSTEM AND METHOD OF AUTOMATED DOCUMENT PAGE CLASSIFICATION AND TARGETED DATA EXTRACTION

(71) Applicant: SHINYDOCS CORPORATION, Kitchener (CA)

(72) Inventors: Merv BOWMAN, Waterloo (CA); Mark KRAATZ, London (CA); Jason William David CASSIDY, Kitchener (CA)

(21) Appl. No.: 18/416,858

(22) Filed: Jan. 18, 2024

Related U.S. Application Data
(60) Provisional application No. 63/480,686, filed on Jan. 19, 2023.

(51) Int. Cl. G06N 20/00; G06F 16/906; G06F 16/93

(52) U.S. Cl. CPC G06N 20/00; G06F 16/906; G06F 16/93

(57) ABSTRACT

A system and method for automated document page classification and targeted data extraction. A method for identifying document page types using deep learning (Artificial Intelligence and Machine Learning), and page classification, based on trained models. The layout of the page, as well as where the features are on a given page, from which text is to be extracted are trained on (with human input guiding the construction) and stored in these models. Different types of pages, including text and images, could then be stored in these models, which can then be used for identifying the content on each page to look for the desired feature from which to extract text. Based on a page prediction, the solution then uses the appropriate pre-trained feature extraction model (if one exists) to extract the areas of interest for further OCR processing (retrieving the text).

### CROSS REFERENCE TO RELATED APPLICATION

This application claims priority to and the benefit of U.S. Provisional Patent Application Ser. No. 63/480,686, entitled “SYSTEM AND METHOD OF AUTOMATED DOCUMENT PAGE CLASSIFICATION AND TARGETED DATA EXTRACTION”, filed on Jan. 19, 2023, the disclosure of which is incorporated herein by reference in its entirety.

### FIELD

This disclosure relates to computer systems and, more specifically, to remote file storage and access.

### BACKGROUND

Content management systems or enterprise content management systems are often used to store files and other data for access by users of an organization's computers.

As organizations continue to accumulate and store an ever-expanding volume and variety of digital content assets, it becomes increasingly more important for there to be applications to enable users to find specific information within these files to meet their immediate needs. Content is frequently added from myriad sources, often without a coherent or cohesive strategy to make the contained information easily or functionally accessible to users.

This issue is compounded by the following common situations:
Data is unstructured, locked away in various formats of documents, scans, images, or other file types, that are traditionally not searchable;
It can be difficult to find a specific page within large documents/binders/project books;
It can take a long time to manually find a specific page within a document;
It can take a long time to extract metadata manually from documents;
Incorrect page orientation during OCR tasks leads to incorrect OCR results;
Human error in classifying documents can make them difficult to find; and
Human error in extracting data wastes time and effort.

In short, existing methods of ingesting and creating search capability within a repository of unstructured digital assets can be limited by the capability of existing content management systems or indexing applications, due to the types of files involved and the necessity for human intervention.

### SUMMARY

A system and method for automated document page classification and targeted data extraction. A method for identifying document page types using deep learning (Artificial Intelligence and Machine Learning), and page classification, based on trained models. The layout of the page, as well as where the features are on a given page, from which text is to be extracted and trained on (with human input guiding the construction) and stored in these models. Different types of pages, including text and images, could then be stored in these models, which can then be used for identifying the content on each page to look for the desired feature from which to extract text. Based on a page prediction, the solution then uses the appropriate pre-trained feature extraction model (if one exists) to extract the areas of interest for further OCR processing (retrieving the text).

### BRIEF DESCRIPTION OF THE DRAWINGS

The drawings illustrate, by way of example only, embodiments of the present disclosure.

FIG. 1 is a block diagram of a networked computer system.

FIG. 2 is a block diagram of a user computer device.

FIG. 3 is a diagram that illustrates an example of an alignment check before targeted feature extraction.

FIG. 4 is a diagram that illustrates an Auto Page Alignment workflow.

FIG. 5 is a diagram that illustrates a Training or Teach Me workflow.

FIG. 6 is a diagram that illustrates a Page Predictions workflow.

FIG. 7 is a diagram that illustrates a Find and Custom Trained Features workflow.

### DETAILED DESCRIPTION

Embodiments of this disclosure look to implement machine-learning (ML) and artificial intelligence (AI) techniques to train a system to find and extract valuable information from files within a content repository based upon parameters that are defined by the user.

The system does not discriminate on what the actual context of the document or image is; it relies on the general structure of the page the same way humans do, to an extent. When a human looks at a page, they are capable of very quickly identifying what the page is (for the most part), and after having identified the page, they then look for particular data points or features within it.

The Automated Document Page Classification and Targeted Data Extraction application is based on the theory that human learning is based on an acquired knowledge or reference model that is saved and retrieved for later access when the brain recognizes that it is needed.

As an example, a typical human probably learned what a red apple was at a very young age. They were told that a red apple is an apple based on it having certain visual and tactile characteristics: it is circular, it is hard, it has a stem, it can be predominantly red (or perhaps a blend of red and some variant of green) and is within a certain range of expected size and mass. These learned characteristics of the apple enables one to positively identify that the object is an apple. After it is known that it's an apple, the brain can start to think of what it may taste like.

When presented with another object, for instance a cell phone, the brain knows not to apply the same logic that a cell phone tastes like an apple because it already knows that it's not an apple due to the lack of qualifying characteristics. The brain is able to almost instantaneously classify (and recognize) the cell phone as something different from an apple and therefore applies its acquired logic relevant to the characteristics of the phone.

In the case of the Automated Document Page Classification and Targeted Data Extraction application, the intent is to train the machine to identify elements of the pixelized document to extract, and then further apply classification logic to patterns it finds within the images it scans.

By emulating the way people consciously or sub-consciously see an object, model after model will enable the system to identify documents based upon a classification (i.e., a purchase order). Once a document has been positively identified as being type “purchase order”, further modeling is applied to extract the data elements within that document. Using the purchase order example, the “Bill to” metadata may be the information of greatest interest. Instead of looking at the entire page of a document, the process focuses the field of reference to just that one area per page within a document and then performs the same model identity concept on each piece of needed data within that key area.

The ability to quickly train custom Automated Document Page Classification and Targeted Data Extraction classifiers for all page types within a datastore, ranging from small, large, good to bad quality documents, including images, is critical to the success of this methodology.

This process converts all documents into an image format to enable the classification process. An advantage of this approach is that there is no requirement for text to be present in order to perform the page classifications. Classifications are performed and processed based upon patterns of pixels within the image file, meaning it can be performed even on non-text or non-numerical elements of the document. This enables the classification process to distinguish virtually any element contained within the document, which provides improvements when dealing with bad scans or simply bad handwriting.

In conjunction with performing a classification of the document's content, the system can be trained to perform additional custom page feature extraction to further leverage higher fidelity search capabilities.

Configuration of the application allows setting the number of mandatory features each model must find before a page will save the extracted features. For example, if the number of features that have been successfully extracted was 2, but the mandatory features requirements were set to 3, the resulting features found will not be saved and indexed.

This is a feature that controls the ability to challenge the predictions that occur to help prevent false positives. As another example, a poor-quality scan of an invoice (INV) is run through the application and is subjected to 4 prediction models. Out of the 4 prediction models, 2 predictions predict the page as an invoice at 90%, and 2 other predictions say it's a purchase order (PO) at 95%. Firstly the 95% prediction will be used to try to extract the targeted data, but the result is that no features are identified using the PO feature extraction model. Next, it will try the next highest-scored prediction (INV at 90%) and try to identify the features. This time, all mandatory features are identified, and the system updates the prediction that it is an INV and NOT a PO. In this scenario, multiple models are used to identify what the page type is, using different combinations of predictors, but is supported by validation using object detection.

Once the pages within the documents have been classified, and the key information has been automatically extracted, the data can be provided to users for their intended analytical purpose.

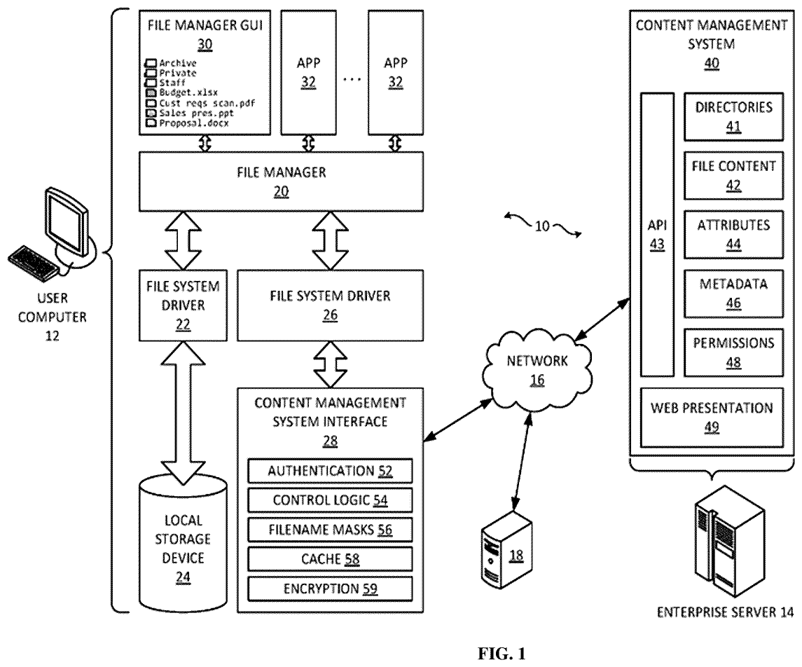

FIG. 1 shows a networked computer system 10 according to the present invention. The system 10 includes at least one user computer device 12 and at least one server 14 connected by a network 16.

The user computer device 12 can be any computing device such as a desktop or notebook computer, a smartphone, tablet computer, and the like. The user computer device 12 may be referred to as a computer.

The server 14 is a device such as a mainframe computer, blade server, rack server, cloud server, or the like. The server 14 may be operated by a company, government, or other organization and may be referred to as an enterprise server or an enterprise content management (ECM) system.

The network 16 can include any combination of wired and/or wireless networks, such as a private network, a public network, the Internet, an intranet, a mobile operator's network, a local-area network, a virtual-private network (VPN), and similar. The network 16 operates to communicatively couple the computer device 12 and the server 14.

In a contemplated implementation, a multitude of computer devices 12 connect to several servers 14 via an organization's internal network 16. In such a scenario, the servers 14 store documents and other content in a manner that allows collaboration between users of the computer devices 12, while controlling access to and retention of the content. Such an implementation allows large, and often geographically diverse, organizations to function. Document versioning or/and retention may be required by some organizations to meet legal or other requirements.

The system 10 may further include one or more support servers 18 connected to the network 16 to provide support services to the user computer device 12. Examples of support services include storage of configuration files, authentication, and similar. The support server 18 can be within a domain controlled by the organization that controls the servers 14 or it can be controlled by a different entity.

The computer device 12 executes a file manager 20, a local-storage file system driver 22, a local storage device 24, a remote-storage file system driver 26, and a content management system interface 28.

The file manager 20 is configured for receiving user file commands from a user interface (e.g., mouse, keyboard, touch screen, etc.) and outputting user file information via the user interface (e.g., display). The file manager 20 may include a graphical user interface (GUI) 30 to allow a user of the computer 12 to navigate and manipulate hierarchies of folders and files, such as those residing on the local storage device 24. Examples of such include Windows® Internet Explorer and macOS® Finder. The file manager 20 may further include an application programming interface (API) exposed to one or more applications 32 executed on the computer 12 to allow such applications 32 to issue commands to read and write files and folders. Generally, user file commands include any user action (e.g., user saves a document) or automatic action (e.g., application's auto-save feature) performed via the file manager GUI 30 or application 32 that results in access to a file. The file manager GUI 30 and API may be provided by separate programs or processes. For the purposes of this disclosure, the file manager 20 can be considered to be one or more processes and/or programs that provide one or both of the file manager GUI 30 and the API.

The local-storage file system driver 22 is resident on the computer 12 and provides for access to the local storage device. The file system driver 22 responds to user file commands, such as create, open, read, write, and close, to perform such actions on files and folders stored on the local storage device 24. The file system driver 22 may further provide information about files and folders stored on the local storage device 24 in response to requests for such information.

The local storage device 24 can include one or more devices such as magnetic hard disk drive, optical drives, solid-state memory (e.g., flash memory), and similar.

The remote-storage file system driver 26 is coupled to the file manager 20 and is further coupled to the content management system interface 28. The file system driver 26 maps the content management system interface 28 as a local drive for access by the file manager 20. For example, the file system driver 26 may assign a drive letter (e.g., “H:”) or mount point (e.g., “/Enterprise”) to the content management system interface 28. The file system driver 26 is configured to receive user file commands from the file manager 20 and output user file information to the file manager 20. Examples of user file commands include create, open, read, write, and close, and examples of file information include file content, attributes, metadata, and permissions. The remote-storage file system driver 26 can be based on a user-mode file system driver.

The remote-storage file system driver 26 can be configured to delegate callback commands to the content management system interface 28. The callback commands can include file system commands such as Open, Close, Cleanup, CreateDirectory, OpenDirectory, Read, Write, Flush, GetFileInformation, GetAttributes, FindFiles, SetEndOfFile, SetAttributes, GetFileTime, SetFileTime, LockFile, UnLockFile, GetDiskFreeSpace, GetFileSecurity, and SetFileSecurity.

The content management system interface 28 is the interface between the computer 12 and the enterprise server 14. The content management system interface 28 connects, via the network 16, to a content management system 40 hosted on the enterprise server 14. As will be discussed later in this document, the content management system interface 28 can be configured to translate user commands received from the driver 26 into content management commands for the remote content management system 40.

The content management system interface 28 is a user-mode application that is configured to receive user file commands from the file manager 20, via the driver 26, and translate the user file commands into content management commands for sending to the remote content management system 40. The content management system interface 28 is further configured to receive remote file information from the remote content management system 40 and to translate the remote file information into user file information for providing to the file manager 20 via the driver 26.

The remote content management system 40 can be configured to expose an API 43 to the content management system interface 28 in order to exchange commands, content, and other information with the content management system interface 28. The remote content management system 40 stores directory structures 41 containing files in the form of file content 42, attributes 44, metadata 46, and permissions 48. File content 42 may include information according to one or more file formats (e.g., “.docx”, “.txt”, “.dxf”, etc.), executable instructions (e.g., an “.exe” file), or similar. File attributes 44 can include settings such as hidden, read-only, and similar. Metadata 46 can include information such as author, date created, date modified, tags, file size, and similar. Permissions 48 can associate user or group identities to specific commands permitted (or restricted) for specific files, such as read, write, delete, and similar.

The remote content management system 40 can further include a web presentation module 49 configured to output one or more web pages for accessing and modifying directory structures 41, file content 42, attributes 44, metadata 46, and permissions 48. Such web pages may be accessible using a computer's web browser via the network 16.

The content management system interface 28 provides functionality that can be implemented as one or more programs or other executable elements. The functionality will be described in terms of distinct elements, but this is not to be taken as limiting. In specific implementations, not all of the functionality needs to be implemented.

The content management system interface 28 includes an authentication component 52 that is configured to prompt a user to provide credentials for access to the content management system interface 28 and for access to the remote content management system 40. Authentication may be implemented as a username and password combination, a certificate, or similar, and may include querying the enterprise server 14 or the support server 18. Once the user of the computer device 12 is authenticated, he or she may access the other functionality of the content management system interface 28.

The content management system interface 28 includes control logic 54 configured to transfer file content between the computer 12 and the server 14, apply filename masks, evaluate file permissions and restrict access to files, modify file attributes and metadata, and control the general operation of the content management system interface 28. The control logic 54 further affects mapping of remote paths located at the remote content management system 40 to local paths presentable at the file manager 20. Path mapping permits the user to select a file via the final manager 20 and have file information and/or content delivered from the remote content management system 40. In one example, the remote files and directories are based on a root path of “hostname/directory/subdirectory” that is mapped to a local drive letter or mount point and directory (e.g., “H:/hostname/directory/subdirectory”).

The content management system interface 28 includes filename masks 56 that discriminate between files that are to remain local to the computer 12 and files that are to be transferred to the remote content management system 40. Temporary files may remain local, while master files that are based on such temporary files may be sent to the remote content management system 40. This advantageously prevents the transmission of temporary files to the remote content management system 40, thereby saving network bandwidth and avoiding data integrity issues (e.g., uncertainty and clutter) at the remote content management system 40.

The content management system interface 28 includes a cache 58 of temporary files, which may include working versions of files undergoing editing at the user computer device 12 or temporary files generated during a save or other operating of an application 32.

The content management system interface 28 includes an encryption engine 59 configured to encrypt at least the cache 58. The encryption engine 59 can be controlled by the authentication component 52, such that a log-out or time out triggers encryption of the cache 58 and successful authentication triggers decryption of the cache 58. Other informational components of the content management system interface 28 may be encrypted as well, such as the filename masks 56. The encryption engine 59 may conform to an Advanced Encryption Standard (AES) or similar.

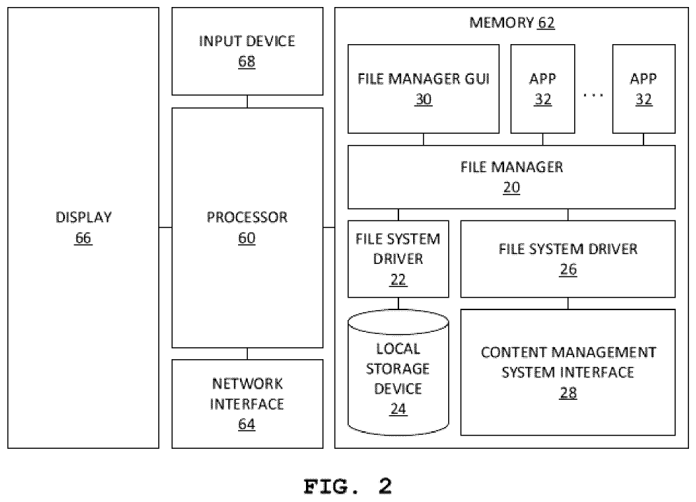

FIG. 2 shows an example of a user computer device 12. The computer device 12 includes a processor 60, memory 62, a network interface 64, a display 66, and an input device 68. The processor 60, memory 62, network interface 64, display 66, and input device 68 are electrically interconnected and can be physically contained within a housing or frame.

The processor 60 is configured to execute instructions, which may originate from the memory 62 or the network interface 64. The processor 60 may be known as CPU. The processor 60 can include one or more processors or processing cores.

The memory 62 includes a non-transitory computer-readable medium that is configured to store programs and data. The memory 62 can include one or more short-term or long-term storage devices, such as a solid-state memory chip (e.g., DRAM, ROM, non-volatile flash memory), a hard drive, an optical storage disc, and similar. The memory 62 can include fixed components that are not physically removable from the client computer (e.g., fixed hard drives) as well as removable components (e.g., removable memory cards). The memory 62 allows for random access, in that programs and data may be both read and written.

The network interface 64 is configured to allow the user computer device 12 to communicate with the network 16 (FIG. 1). The network interface 64 can include one or more of a wired and wireless network adaptor as well as a software or firmware driver for controlling such adaptor.

The display 66 and input device 68 form a user interface that may collectively include a monitor, a screen, a keyboard, keypad, mouse, touch-sensitive element of a touch-screen display, or similar device.

The memory 62 stores the file manager 20, the file system driver 26, and the content management system interface 28, as well as other components discussed with respect to FIG. 1. Various components or portions thereof may be stored remotely, such as at a server. However, for purposes of this description, the various components are locally stored at the computer device 12. Specifically, it may be advantageous to store and execute the file manager 20, the file system driver 26, and the content management system interface 28 at the user computer device 12, in that a user may work offline when not connected to the network 16. In addition, reduced latency may be achieved. Moreover, the user may benefit from the familiar user experience of the local file manager 20, as opposed to a remote interface or an interface that attempts to mimic a file manager.

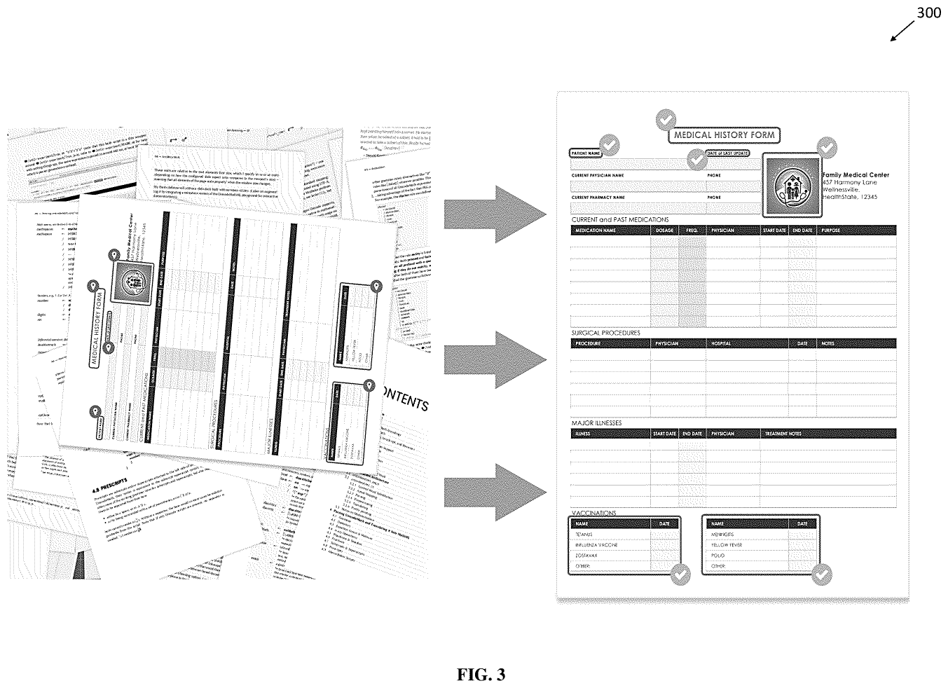

FIG. 3 is a diagram that illustrates an example of an alignment check before targeted feature extraction. According to FIG. 3, there is shown a visual representation 300 of ORB (Oriented FAST and Rotated BRIEF) for finding matches between a template image and the query image that is to be transformed or in other ways aligned. The lines represent visually the found matches (i.e., image to align compared to the template). The template is the source of truth that the image is referenced to. After matches are found, further processing is completed to find the homography matrix and perform the required transformation. This step is critical before the optical character recognition (OCR) is conducted on the features that are found and extracted.

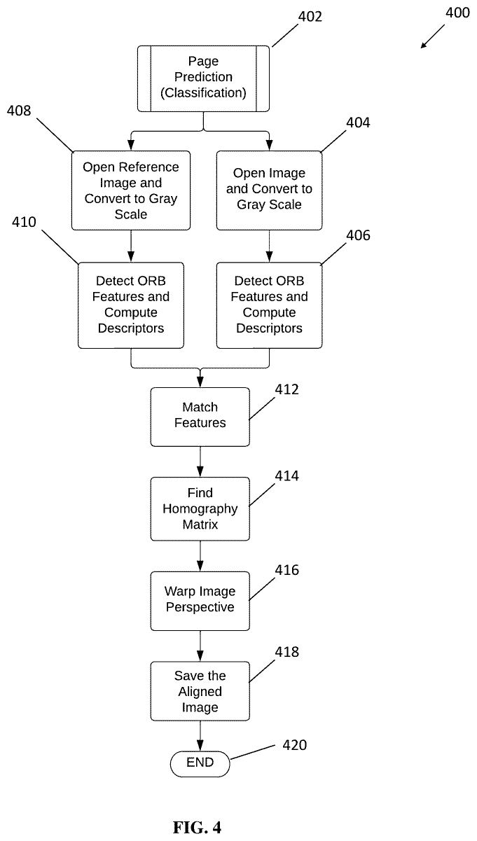

FIG. 4 is a diagram that illustrates an auto page alignment workflow. According to FIG. 4 workflow 400 is disclosed for auto page alignment using ORB and homography. The initial step is page prediction or classification at step 402. Next, the workflow forks into the upper path of opening an image and converting to grayscale at step 404, and then detecting ORB features and computer descriptors at step 406. Furthermore, the workflow follows a parallel path of opening a reference image and converting to grayscale at step 408, and detecting ORB features and computing descriptors at step 410. The parallel paths 404 and 408 occurs simultaneously.

According to FIG. 4, both paths then converge on the step of matching features at step 412. Next it moves to finding homography or a homography matrix at step 414, warping the image perspective at step 416 and then saving the aligned image at 418, at which point the process ends at step 420.

### Principal Component Analysis

Principal Component Analysis (PCA) is a method that is commonly used for dimensionality reduction by projecting each data point onto only the first few principal components to obtain lower-dimensional data while preserving as much of the data's variation as possible. The first principal component can equivalently be defined as a direction that maximizes the variance of the projected data.

PCA is a linear dimensionality reduction and feature extraction for high-dimensional data and is used for selecting the number of components as follows:
Selecting the number of principal components produced by using only the first L eigenvectors gives the truncated transformation.
When selecting the number (n) of features (number of components), those n features are used to identify what document or document type it is.
Depending on the dataset, this can vary to be able to capture all different kinds of documents.
Visually, these are the Eigenvalues or Eigendocuments. Eigendocuments is a term that will be used to describe the application of eigenvectors and eigenvalues to a target document. In this context, it is the result of the feature extraction preprocesses, and the basis on which the feature extraction and classification actions will be performed.
When viewing each Eigendocument's principal component (PC) it is showing the maximum variance per direction
The white areas in the Eigendocuments are the maximum variance in that direction.

There are several benefits of using Principal Component Analysis (PCA) including:
PCA is very useful for noisy data (bad scans) but can also be used on clean data for classification purposes.

### Example 1: If there was a Picture with Dimensions of 64×64=4096=4096 Pixels

PCA was applied and 24 components (features) were selected via the selection rules.
This selection process reduces 4096 potential features down to only 24 features to search through, thereby reducing the volume to be passed to the search function.
When working with high dimensional data, such as documents, PCA is quicker for getting/finding the correct classification.
PCA is not linear regression; PCA gets the minimum error along the PC axis (line) while linear regression gets the minimum distance to the axis (line).

According to the disclosure, PCA can be used for Eigendocuments. A representation of how documents (i.e., high dimensional data) are fed into the system and Principal Component Analysis (PCA) is run and generates the PCA model, which can then be used for classification purposes.

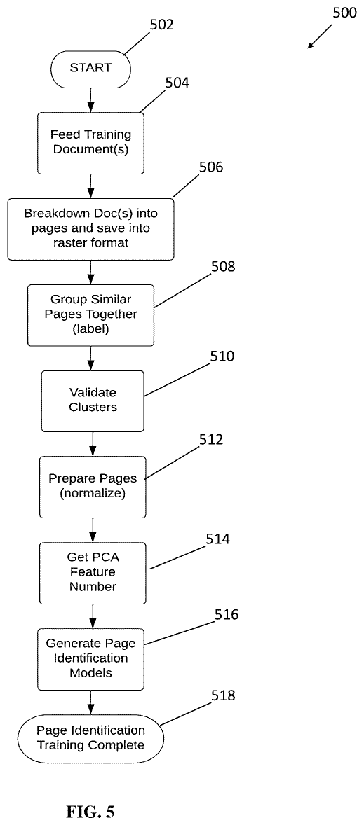

FIG. 5 is a diagram that illustrates a training or “teach me” workflow. According to FIG. 5, the training workflow initiates at step 502 with or without domain knowledge. The first step is to feed training documents at step 504. Next, the documents are broken down into pages and saved as a known image format (e.g., .jpg, .png, .bmp, etc.) at step 506.

According to FIG. 5, the next step is that similar images are grouped together or labelled at step 508. This step 508 can be done manually or through unsupervised clustering. Next, the clusters are validated at step 510 to identify outliers within the clusters of samples. Thereafter, the pages are normalized at step 512 using normalization factors such as portrait, landscape, size, black and white, or colour, as some examples.

According to FIG. 5, the next step is to retrieve a PCA feature number at step 514 where graphs can be shown to advanced users. Next, it will generate page identification models at step 516 by splitting the data into train/test data and generating artifacts. Models such as PCA model, SVC model, SVCLin model, Decision Tree model, and Stack Classifier model can be used at this step. Upon completion of this step, the page identification training is complete at step 518.

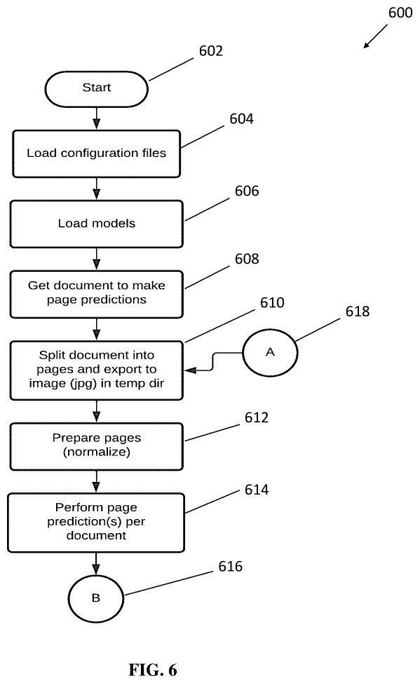

FIG. 6 is a diagram that illustrates a Page Predictions workflow. All classifiers (e.g., SVC, SVNLin, Stack and Decision tree models) are based on the output that is generated from processing the PCA model against each page to obtain the page classification.

According to FIG. 6, the page prediction workflow 600 initiates at step 602 by first loading configuration files at step 604. Information such as labels (page predictions), label map (feature extraction) and/or feature extraction pipeline are loaded at step 604. The next step is to load one or more models at step 606, including PCA model, SVC model, SVCLin model, Stack model, Decision Tree model and Inference models.

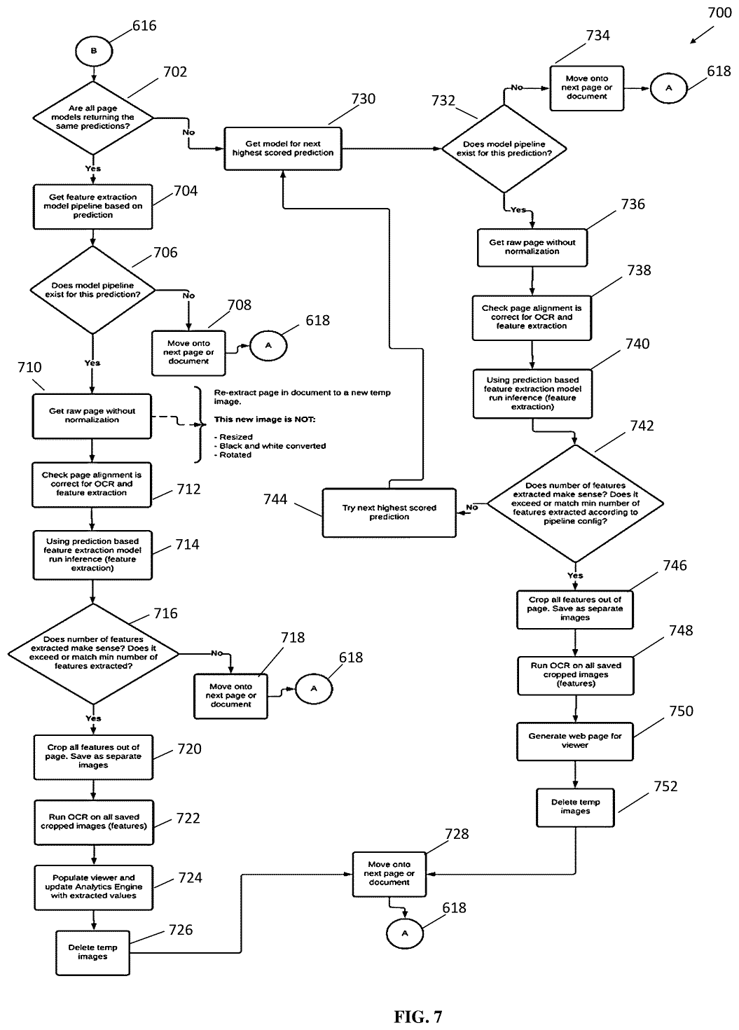

According to FIG. 6, the next workflow step is to get documents to make page predictions at step 608. Once this has completed, the process moves on to splitting the document into pages and exporting the image(s) (i.e., .jpg) into a temporary directory at step 610. Furthermore, the output of Element A at step 618 in FIG. 7 and is also fed as an input into this split document step.

According to FIG. 6, the next step is to normalize the pages at step 612 using normalization factors such as portrait, landscape, size, black and white, and colour, as some examples.

According to FIG. 6, the next step is to perform page predictions per document at step 614 using classification predictions returned based on the PCA model output (e.g., svcPrediction, dtPrediction, svcLinearPrediction, stackedPrediction). Finally, the last step is to perform classifications at step 614 using page number and prediction percentage classification. The output element B at step 616 is used as the input to FIG. 7 as further described below.

FIG. 7 is a diagram that illustrates a Find and Extract Custom Trained Features workflow. This workflow 700 describes how the features get identified and extracted after the page prediction has occurred. According to FIG. 7, input is received as Element B at step 616 from FIG. 6. The first step is to determine whether all page models are returning the same prediction at step 702. If Yes, the next step is to get a feature extraction model pipeline based on the prediction at step 704.

According to FIG. 7, the workflow then determines whether the model pipeline for this prediction exists at step 706. If No pipeline exists for prediction, the user does not need to extract any data from the page type and the workflow can move to the next page or document at step 708, whereby the workflow then loops by to element A at step 618 (i.e., back to FIG. 6).

However, if a model pipeline prediction does exist (i.e., Yes), the next step is to get the raw page without normalization at step 710. This involves re-extracting the page in the document to a new temporary image whereby the new image is not resized, not rotated and not black and white converted.

According to FIG. 7, the next step at step 712 is to check if the page alignment is correct for Optical Character Recognition (OCR) and feature extraction. The next step is to run feature extraction by using the prediction-based feature extraction model running inference at step 714.

According to FIG. 7, the next step is to determine whether the number of features extracted makes sense at step 716 (i.e., does it exceed or match the minimum number of features extracted?). If the answer is No, the workflow moves onto the next page or document at step 718 and the workflow jumps to element A at step 618 (i.e., back to FIG. 6).

According to FIG. 7, if the response is Yes, the workflow then moves to the step of cropping all features out of the page and saving them as separate images at step 720. The next step is to run OCR on all the saved images (features) at step 722.

According to FIG. 7, the next step is to populate the viewer and update the Analytics Engine with the extracted values at step 724, followed by the step of deleting the temporary images at step 726. Finally, the workflow moves onto the next page or document at step 728 and jumps to element A at step 618 (i.e., back to FIG. 6).

According to FIG. 7, referring back to the start to the No branch of all page models returning the same prediction at step 702, the first step is to get a model for the next highest scored prediction at step 730. The next step is to determine whether the model pipeline exists for this prediction at step 732.

According to FIG. 7, if No model pipeline exists for this prediction, the user does not need to extract any further data from this page type at step 732, but the page still gets indexed with the page prediction. The process moves onto the next page or document at step 734 and reverts back to element A at step 618 (i.e., FIG. 6).

According to FIG. 7, if a model pipeline exists for this prediction (i.e., Yes), the workflow gets the raw page without normalization at step 736. The next step is to check that the page alignment is correct for OCR and feature extraction at step 738. Next, using the feature extraction, the prediction-based feature extraction model runs inferences at step 740.

According to FIG. 7, the workflow determines whether the number of features extracted makes sense at step 742. Does it exceed or match the minimum number of features extracted according to the pipeline configuration? If the response is No, the workflow tries the next highest scored prediction at step 744 and loops back to the step of getting the model for the next highest scored prediction at step 730.

According to FIG. 7, if the response is Yes, the workflow crops all the features out of the page and saves them as separate images at step 746. The next step is to run OCR on all saved cropped images or features at step 748.

According to FIG. 7, the next step is to generate the web page for a viewer at step 750. This display step at step 750 includes displaying page prediction, page number, full document path, key-values (e.g., feature name and value) and inference pages. This data can also be added to the index.

According to FIG. 7, the next step is to delete the temporary images at step 752 and then move onto the next page or document and the workflow jumps to element A at step 728 (i.e., back to FIG. 6).

According to the disclosure, the Automated Document Page Classification and Targeted Data Extraction method is not industry-specific and can be trained to extract data on any page within a document with minimal sample data. It can also process and complete the extraction using local computing resources (no cloud API calls). The custom annotation process during the training phase ensures the required data can be identified and extracted—regardless of the structure of the source data.

According to the disclosure, the Automated Document Page Classification and Targeted Data Extraction method looks to identify and extract not only text, but also non-text elements found within the target documents and files. Furthermore, the ability to extract elements based on shape and pixel patterns opens up a search and match capability far beyond that of traditional text- or character-based search techniques.

According to the disclosure, a computer-implemented method for page identification training for an automated document page classification and data extraction system with or without domain knowledge is disclosed. The method comprising the steps of feeding training documents into the data page classification and data extraction system, breaking down the training documents into pages, saving the training documents into pixel-based raster format, grouping similar documents together into clusters, validating the one or more clusters, normalizing the pages using a normalization factor, retrieving a Principal Component Analysis (PCA) feature number, generating page identification models and completing page identification training.

According to the disclosure, the page identification training of the method further comprising “teach me” training. The step of saving into raster format further comprises saving in a known image format, selecting from a list consisting of jpeg, bitmap or portable network graphic (png). The step of grouping similar documents together further comprising labelling the documents.

According to the disclosure, the step of grouping similar documents of the method can be done manually or through unsupervised clustering. The normalization factors of the method are selected from list consisting of portrait, landscape, size, black and white, and colour.

According to the disclosure, the Principal Component Analysis (PCA) of the method is used for dimensionality reduction by projecting each data point onto only the first few principal components to obtain lower-dimensional data while preserving as much of the data's variation as possible.

According to the disclosure, the step of generating page identification models of the method further comprises splitting the data into training or test data and generating artifacts. The identification model of the method is selected from a list consisting of PCA model, SVC model, SVCLin model, Decision Tree model, and Stack Classifier model.

According to the disclosure, a computer-implemented method for page prediction for an automated document page classification and data extraction system using classifiers is disclosed. The method comprising the steps of loading one or more configuration files, loading one or more PCA model, retrieving documents to make page predictions, splitting the documents into pages, exporting images in the document into a temporary directory, preparing pages for normalization using one or more normalization factors and performing page prediction in the document using classification predictions returned based on the PCA model output, wherein the classifiers are based on the output that is generated from processing the PCA model against each page to obtain the page classification.

According to the disclosure, loading configuration files of the method further comprises loading information such as labels (page predictions), label map (feature extraction) or a feature extraction pipeline. The step of loading one or more PCA model includes loading a PCA model, a SVC model, a SVCLin model, a Stack model, a Decision Tree model and an Inference models.

According to the disclosure, the normalization factors of the method is selected from a list consisting of portrait, landscape, size, black and white, and colour. The PCA model output of the method further comprises svcPrediction, dtPrediction, svcLinearPrediction and stackedPrediction.

According to the disclosure, the classifiers of the method include SVC, SVNLin, Stack and Decision tree models. The method further comprises performing classifications using page number and prediction percentage classification.

According to the disclosure, a computer-implemented method for automatic page alignment for an automated document page classification and data extraction system. The method comprising the steps of executing routines for page prediction, opening a reference image and converting the reference image to grey scale, opening a regular image and converting the regular image to grey scale, detecting ORB (Oriented FAST and Rotated BRIEF) features in the reference image and the regular image, computing descriptors from the ORB features, matching the ORB features from the reference image and the regular image, finding a homography matrix, warping an image perspective an saving the aligned image.

According to the disclosure, the method further comprises executing routines for page classification.

Implementations disclosed herein provide systems, methods and apparatus for generating or augmenting training data sets for machine learning. The functions described herein may be stored as one or more instructions on a processor-readable or computer-readable medium. The term “computer-readable medium” refers to any available medium that can be accessed by a computer or processor. By way of example, and not limitation, such a medium may comprise RAM, ROM, EEPROM, flash memory, CD-ROM or other optical disk storage, magnetic disk storage or other magnetic storage devices, or any other medium that can be used to store desired program code in the form of instructions or data structures and that can be accessed by a computer. It should be noted that a computer-readable medium may be tangible and non-transitory. As used herein, the term “code” may refer to software, instructions, code or data that is/are executable by a computing device or processor. A “module” can be considered as a processor executing computer-readable code.

A processor as described herein can be a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor can be a microprocessor, but in the alternative, the processor can be a controller, or microcontroller, combinations of the same, or the like. A processor can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor may also include primarily analog components. For example, any of the signal processing algorithms described herein may be implemented in analog circuitry. In some embodiments, a processor can be a graphics processing unit (GPU). The parallel processing capabilities of GPUs can reduce the amount of time for training and using neural networks (and other machine learning models) compared to central processing units (CPUs). In some embodiments, a processor can be an ASIC including dedicated machine learning circuitry custom-built for one or both of model training and model inference.

The disclosed or illustrated tasks can be distributed across multiple processors or computing devices of a computer system, including computing devices that are geographically distributed. The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

As used herein, the term “plurality” denotes two or more. For example, a plurality of components indicates two or more components. The term “determining” encompasses a wide variety of actions and, therefore, “determining” can include calculating, computing, processing, deriving, investigating, looking up (e.g., looking up in a table, a database, or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.” While the foregoing written description of the system enables one of ordinary skill to make and use what is considered presently to be the best mode thereof, those of ordinary skill will understand and appreciate the existence of variations, combinations, and equivalents of the specific embodiment, method, and examples herein. The system should therefore not be limited by the above-described embodiment, method, and examples, but by all embodiments and methods within the scope and spirit of the system. Thus, the present disclosure is not intended to be limited to the implementations shown herein but is to be accorded the widest scope consistent with the principles and novel features disclosed herein.

What is claimed is:

1. A computer-implemented method for page identification training for an automated document page classification and data extraction system with or without domain knowledge, the method comprising the steps of:
feeding training documents into the data page classification and data extraction system;
breaking down the training documents into pages;
saving the training documents into pixel-based raster format;
grouping similar documents together into clusters;
validating the one or more clusters;
normalizing the pages using a normalization factor;
retrieving a Principal Component Analysis (PCA) feature number;
generating page identification models; and
completing page identification training.

2. The method of claim 1 wherein page identification training further comprising “teach me” training.

3. The method of claim 1 wherein saving into raster format further comprises saving in a known image format, selecting from a list consisting of jpeg, bitmap or portable network graphic (png).

4. The method of claim 1 wherein the grouping similar documents together further comprising labelling the documents.

5. The method of claim 1 wherein grouping similar document can be done manually or through unsupervised clustering.

6. The method of claim 1 wherein normalization factors are selected from list consisting of portrait, landscape, size, black and white, and colour.

7. The method of claim 1 wherein Principal Component Analysis (PCA) is used for dimensionality reduction by projecting each data point onto only the first few principal components to obtain lower-dimensional data while preserving as much of the data's variation as possible.

8. The method of claim 1 wherein generating page identification models further comprises splitting the data into training or test data and generating artifacts.

9. The method of claim 1 wherein the identification model is selected from a list consisting of PCA model, SVC model, SVCLin model, Decision Tree model, and Stack Classifier model.

10. A computer-implemented method for page prediction for an automated document page classification and data extraction system using classifiers, the method comprising the steps of:
loading one or more configuration files;
loading one or more PCA model;
retrieving documents to make page predictions;
splitting the documents into pages;
exporting images in the document into a temporary directory;
preparing pages for normalization using one or more normalization factors; and
performing page prediction in the document using classification predictions returned based on the PCA model output;
wherein the classifiers are based on the output that is generated from processing the PCA model against each page to obtain the page classification.

11. The method of claim 10 wherein loading configuration files further comprises loading information such as labels (page predictions), label map (feature extraction) or a feature extraction pipeline.

12. The method of claim 10 wherein loading one or more PCA model includes loading a PCA model, a SVC model, a SVCLin model, a Stack model, a Decision Tree model and an Inference models.

13. The method of claim 10 wherein the normalization factors is selected from a list consisting of portrait, landscape, size, black and white, and colour.

14. The method of claim 10 wherein the PCA model output further comprises svcPrediction, dtPrediction, svcLinearPrediction and stackedPrediction.

15. The method of claim 10 wherein the classifiers include SVC, SVNLin, Stack and Decision tree models.

16. The method of claim 10 further comprises performing classifications using page number and prediction percentage classification.

17. A computer-implemented method for automatic page alignment for an automated document page classification and data extraction system, the method comprising the steps of:
executing routines for page prediction;
opening a reference image and converting the reference image to grey scale;
opening a regular image and converting the regular image to grey scale;
detecting ORB (Oriented FAST and Rotated BRIEF) features in the reference image and the regular image;
computing descriptors from the ORB features;
matching the ORB features from the reference image and the regular image;
finding a homography matrix;
warping an image perspective; and
saving the aligned image.

18. The method of claim 16 further comprises executing routines for page classification.
